(19) United States
(12) Patent Application Publication
(10) Pub. No.: US 2025/0217864 A1
(43) Pub. Date: Jul. 3, 2025

(54) SYSTEMS AND METHODS FOR GENERATING KNOWLEDGE-AWARE EXPLAINABLE RECOMMENDATIONS

(71) Applicant: Robert Bosch GmbH, Stuttgart (DE)

(72) Inventors: ANTHONY M. COLAS, MIAMI, FL (US); JUN ARAKI, SAN JOSE, CA (US); ZHENGYU ZHOU, FREMONT, CA (US); BINGQING WANG, SAN JOSE, CA (US); ZHE FENG, MOUNTAIN VIEW, CA (US)

(21) Appl. No.: 18/400,266

(22) Filed: Dec. 29, 2023

(51) Int. Cl. G06Q 30/0601; G06F 16/242; G06F 16/248

(52) U.S. Cl. CPC G06Q 30/0631; G06F 16/243; G06F 16/248

(57) ABSTRACT

A method includes receiving query data, receiving item data, initializing the query data as at least one natural language query token, and initializing the item data as at least one natural language item token. The method also includes generating a knowledge graph for the item based on the at least one natural language item token, flattening the knowledge graph for the item to generate a knowledge graph string, mapping at least one token associated with the knowledge graph string and the at least one natural language query token to an embedding vector using a matrix of parameters, and providing, to a machine learning model, the embedding vector. The method also includes receiving, from the machine learning model, a recommendation and a natural language explanation of the recommendation, and providing, to a user at a display, the recommendation and the natural language explanation of the recommendation.

### TECHNICAL FIELD

The present disclosure relates to the using machine learning models, and in particular to systems and methods for generating knowledge-aware explainable recommendations using machine learning models.

### BACKGROUND

Increasingly, recommendation systems have become a prominent component of online applications where user engagement is involved. Traditional algorithms, which filter items based on similar user purchase history, are categorized as collaborative filtering. Typically, recommendation systems are domain-specific, and are seen most often used in e-commerce and movie-related items.

Such a recommendation system typically filters or identifies items, such as appliances, vehicles, consumer electronics, and/or the like, which can then be suggested to users based on the purchase history of the user, relatedness factors associated with the suggested items and a global purchase history of items (e.g., including the purchase history of some or all other users). The system may then present the user with the suggested items, with the goal being to maximize user engagement on the system, which may include, for example, a web application.

### SUMMARY

An aspect of the disclosed embodiments includes a method for providing a recommendation and a natural language explanation of the recommendation. The method includes receiving query data, receiving item data, initializing the query data as at least one natural language query token, and initializing the item data as at least one natural language item token. The method also includes generating a knowledge graph for the item based on the at least one natural language item token, flattening the knowledge graph for the item to generate a knowledge graph string, mapping at least one token associated with the knowledge graph string and the at least one natural language query token to an embedding vector using a matrix of parameters, and providing, to a machine learning model, the embedding vector. The method also includes receiving, from the machine learning model, a recommendation and a natural language explanation of the recommendation, and providing, to a user at a display, the recommendation and the natural language explanation of the recommendation.

Another aspect of the disclosed embodiments includes a system for providing a recommendation and a natural language explanation of the recommendation. The system includes a processor, and a memory. The memory includes instructions that, when execute by the processor, cause the processor to: receive query data; receive item data; initialize the query data as at least one natural language query token; initialize the item data as at least one natural language item token; generate a knowledge graph for the item based on the at least one natural language item token; flatten the knowledge graph for the item to generate a knowledge graph string; map at least one token associated with the knowledge graph string and the at least one natural language query token to an embedding vector using a matrix of parameters; provide, to a machine learning model, the embedding vector; receive, from the machine learning model, a recommendation and a natural language explanation of the recommendation; and provide, to a user at a display, the recommendation and the natural language explanation of the recommendation.

Another aspect of the disclosed embodiments includes an apparatus for providing a recommendation and a natural language explanation of the recommendation. The apparatus includes a processor, and a memory. The memory includes instructions that, when executed by the processor, cause the processor to: receive query data; receive item data; initialize the query data as at least one natural language query token; initialize the item data as at least one natural language item token; generate a star-shaped knowledge graph for the item based on the at least one natural language item token; flatten the knowledge graph for the item to generate a knowledge graph string; map at least one token associated with the knowledge graph string and the at least one natural language query token to an embedding vector using a matrix of randomly initialized parameters; provide, to a machine learning model, the embedding vector; receive, from the machine learning model, a recommendation and a natural language explanation of the recommendation; and provide, to a user at a display, the recommendation and the natural language explanation of the recommendation.

### BRIEF DESCRIPTION OF THE DRAWINGS

FIG. 1 generally illustrates a system for training a neural network, according to the principles of the present disclosure.

FIG. 2 generally illustrates a computer-implemented method for training and utilizing a neural network, according to the principles of the present disclosure.

FIG. 3A generally illustrates a knowledge graph grounded recommendation explanation system, including the model workflow, according to the principles of the present disclosure.

FIG. 3B generally illustrates a training method for training a model using item descriptions, according to the principles of the present disclosure.

FIG. 3C generally illustrates an inference method, according to the principles of the present disclosure.

FIG. 3D generally illustrates a knowledge graph and corresponding natural language explanation, according to the principles of the present disclosure.

FIG. 4 is a flow diagram generally illustrating a recommendation and explanation generation method, according to the principles of the present disclosure.

FIG. 5 depicts a schematic diagram of an interaction between a computer-controlled machine and a control system, according to the principles of the present disclosure.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to the principles of the present disclosure.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

As described, increasingly, recommendation systems have become a prominent component of online applications where user engagement is involved. Traditional algorithms, which filter items based on similar user purchase history, are categorized as collaborative filtering. Typically, recommendation systems are domain-specific, and are seen most often used in e-commerce and movie-related items.

Such a recommendation system typically filters or identifies items, such as appliances, vehicles, consumer electronics, and/or the like, which can then be suggested to users based on the purchase history of the user, relatedness factors associated with the suggested items and a global purchase history of items (e.g., including the purchase history of some or all other users). The system may then present the user with the suggested items, with the goal being to maximize user engagement on the system, which may include, for example, a web application.

Typically, when providing a query to the recommendation system, the system may compute a high score for items which appear unrelated. Consequently, the user of such a system may be confused by the system and lose trust in the recommendation algorithm. If the user attempts to investigate to understand why an item was recommended, the user may then embark on a time-consuming process, including manually iterating through the recommended items and corresponding features, which may not result in a useful justification or understanding for the recommendation (e.g., especially if multiple valid items are recommended). In another scenario, a query may be represented through keywords, sentences, or documents, in which the user describes requirements for what the user is interested in purchasing. Here, the recommendation system may assist in creating an offer to the user, in which many items are recommended to fulfill the described requirements. In this scenario, while there may not be any unrelated recommendations presented to the user, the user may still want to understand how the suggested items were determined and/or a representative may want to verify the offer before it is presented to the user.

Existing recommendation systems typically leverage item reviews formulated by users to generate justifications with natural language sentences. However, this reliance on reviews poses three problems. First, the explanations are usually not objective, because users typically review items through sentiment-based words, excluding specific item features. Second, because reviews typically describe an experience of a user with the item, the reviews may be extremely broad and sparse, and therefore resulting explanations based on the reviews tend to be irrelevant to a target user. Third, because the systems rely on reviews, they cannot account for new items which have never been purchased before, nor can the system provide justifications for item catalogues which may not have reviews available.

Accordingly, systems and methods, such as the systems and methods described herein, configured to provide recommendations and an explanation for the recommendation, may be desirable. In some embodiments, the systems and methods described herein may be configured to provide users with a natural language justification for an item was suggested. The systems and methods described herein may be configured to automatically generate the justification for users. The systems and methods described herein may be configured to provide explanations and/or justifications for, a recommended item, that are to concise, objective, and tailored for a corresponding item category. The systems and methods described herein may be configured to update explanations based on item changes and account for changes in item features.

In some embodiments, the systems and methods described herein may be configured to use natural language processing (NLP) and knowledge graphs (KG). The systems and methods described herein may be configured to provide a KG based explainable recommendation system in which a natural language text is generated to serve as the explanation for why an item is recommended to a user. The systems and methods described herein may be configured to receive a query and item as input. The query may include a user in a traditional user-interfaced recommendation system, customer requirements serving as constraints on the possible recommended items, and/or other suitable query. The systems and methods described herein may be configured to output (i) a rating for the query-item pair, denoting whether the item is suitable given the query and (ii) a description of the item KG in natural language sentences as an explanation for the recommended item score.

The systems and methods described herein may be configured to user the KG for fact-grounded, specific explanations. The systems and methods described herein may be configured to represent the query and item as a KG for to provide an explainable recommendation, where the recommendation basis is dependent on how the query and item features relate (e.g., users having shared features with the paired item).

The systems and methods described herein may be configured to user the KG as a connecting component between different items, which may not have an inherent connection. The systems and methods described herein may be configured to, convert the KG into a narrative to answer the question of why an item may have been recommended.

In some embodiments, the systems and methods described herein may be configured to address the issues of previous explainable recommendation systems. For example, the systems and methods described herein may be configured to define a KG as a multi-relational graph G=(V,E), where V is the set of entity vertices and E⊂V×R×V is the set of edges connecting entities with a relation from R. Each item within a catalogue database includes a respective KG which can be extracted from text, imported from an item database, or manually curated. The KG may include features detailing a specific item.

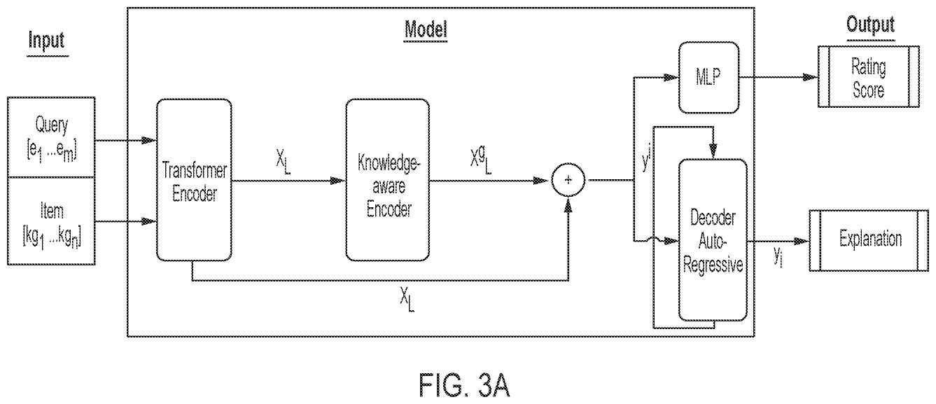

The systems and methods described herein may be configured to user the KG to draw information from a particular item in order to articulate and describe the justification of a recommendation for the item. The systems and methods described herein may be configured to provide a data-driven objective explanation as to why an item was recommended using pre-defined features of the item. FIG. 3D, generally illustrates an example of the KG and explanation, where the KG describes a “300 Series Freestanding Counter-Depth Side-by-Side Refrigerator.” The nodes and/or edges of the KG correspond to the explanation of the item. The user may notice the item was recommended because it may have satisfied provided constraints or preferences from previous purchases. For example, the user may have previously bought a refrigerator with both left and right door options and may be looking to replace such refrigerator.

Given a query q and item i, where the query is represented via purchase history or user requirements, and the item is represented via its corresponding KG g, the systems and methods described herein may be configured to generate a natural language explanation e as to why item i was recommended for query q. Here, the natural language explanation e is a verbalization or description of g, and thus an item specific explanation grounded on the given structured input data.

In some embodiments, the systems and methods described herein may be configured to receive a query based on purchase history and/or customer needs, which can be formulated from a feature set or user KG or documents of varying lengths.

With reference to FIG. 3A, a knowledge-aware explanation network is generally illustrated. As described, the systems and methods described herein may be configured to receive a query q and an item i. The systems and methods described herein may be configured to initialize a query as a set of natural language tokens, i.e., as a user's purchase history or a customer's requirements. The systems and methods described herein may be configured to represent a user's purchase history as a string representation of previously purchased items. The systems and methods described herein may be configured to represent customer's requirements via the tokenization of extracted keywords within the document.

The systems and methods described herein may be configured to initialize an item as the set of natural language tokens which make up the KG for the item. The systems and methods described herein may be configured to, using transformer-based encoders, flatten the KG into a string, where the item (topic) of the graph constitutes the head entity. Therefore, each graph is star-shaped, where the item entity is the center node of the graph. Additionally, or alternatively, the systems and methods described herein may be configured to add special denotation tokens <[head], [rel], [tail]> at the start of each graph component, in order to add additional context to the flattened graph string. The input data may be represented as I=[q,i]=[e₁, . . . ,eₘ,kg₁, . . . ,kgₙ], where e₁, . . . , eₘ and kg₁, . . . ,kgₙ denote the natural language tokens which represent a query and tokens from the linearized KG, respectively.

In order to properly encode these tokens, the systems and methods described herein may be configured to construct a dictionary, mapping integers to tokens or leverage a pre-trained tokenizer. The systems and methods described herein may be configured to map the tokens to an embedding vector by using a matrix with randomly initialized parameters.

The systems and methods described herein may be configured to use KG components to provide a recommendation and its natural language explanation. The systems and methods described herein may be configured to directly encapsulate KG information into the model input. When training the model for recommendation explanation, the systems and methods described herein may be configured to expose the model to ground truth justifications and/or explanations from which the KG is expected to verbalize or describe.

The systems and methods described herein may be configured to transformer-style architecture, where the query and item tokens (KG) are encoded via an attention mechanism. The systems and methods described herein may be configured to the transformer encoder may include L layers, which each include a multi-head self-attention and position-wise feed-forward network, which encodes a position of a token in the input sequence. At the l-th layer of the L transformer layers, self-attention is evaluated as:

$${X}_{l} = Attn ( Q , K , V ) = {softmax}^{( \frac{{QK}^{⊤}}{\sqrt{{d}_{k}}} ) V} . \qquad ( 1 )$$

where, Q represents a query, K a key, and V a value, where Q=Xₗ₋₁Wₗ^{Q},K=Xₗ₋₁Wₗ^{K}, and V=Xₗ₋₁Wₗ₋₁^{V}. Differentiation is made for query q when calculating attention from query q in the input. W are learnable parameters, with size dₖ×dₖ, where dₖ is the dimension of word vectors, and Xₗ₋₁ denotes the input vector for I. The systems and methods described herein may be configured to use a fully connected encoder as an initial representation of the query and item. The systems and methods described herein may be configured to update query q and item i into an initial graph-free representation, where the next component graph-aware encoding updates this representation for both the recommendation and explanation task. The transformer encoder may be initialized via a pre-trained language model.

The systems and methods described herein may be configured to encode the graph-topology by representing users as the vector set of items purchased, and representing items as a vector set of items purchased by the same user. The systems and methods described herein may be configured to propagate this representation through connections in an associative knowledge graph.

The systems and methods described herein may be configured to use a knowledge-aware attention mechanism to learn the weights of entities in a corresponding entity set to generate a weighted representations of entities which represent a user (e.g., or query) and item. The graph components may be represented via tokenization or as unique integers. The systems and methods described herein may be configured to provide a generative explainable recommendation system. The systems and methods described herein may be configured to output a recommendation rating and natural language explanation. The systems and methods described herein may be configured to, because the explanation is grounded on knowledge graph facts, represent an input through a corresponding KG. In the case where query q is a user, the systems and methods described herein may be configured to represent q as its corresponding purchased item set.

The systems and methods described herein may be configured to augment the initial encoding of graph tokens with a graph-aware encoding. The systems and methods described herein may be configured to construct entity and/or relation vectors from the tokens vectors of the KG through a pooling operation which averages the tokens contained within entities and/or relations. Thus, the input, represented as X_{L} from the previous module now becomes X_{L}_{^{g}}. The systems and methods described herein may be configured to apply a graph-aware attention mechanism to update X_{L}_{^{g}} via a topological masking scheme M_{g}. Specifically, X_{L}_{^{g}} is updated to become:

$$\tilde{{X}_{{l}^{g}}} = {Attn}_{M , T} ( Q , K , V ) = {softmax}^{( \frac{{QK}^{⊤}}{\sqrt{{d}_{k}}} + {M}_{g} ) V} . \qquad ( 2 )$$

where, query Q, key K, and value V are computed via the input vector and new learnable parameters W_{g}. Here the mask M_{g} is of size (n+q)×(n+q), where n denotes the number of components in a given KG (entities+relations) from i and q denotes the components in the input query. Thus, M_{g} acts as an adjacency matrix for the given input and encodes the topological structure of the KG for a given item, where each row and/or column corresponding to m is an entity/relation of the corresponding KG. Note the similarities between the graph-aware transformer and previously defined self-attention equation. The systems and methods described herein may be configured to introduce a new query representation q into mask M_{g}, in which its definition is dependent on how the task defines query q. For example, in the case of traditional user recommendation systems, where a query is a user, such input is represented via its purchased item set. Therefore, the query item set may attend to item entity names in the corresponding KG i. Alternatively, if query q is defined as features extracted from an offer document, the features may attend to corresponding features in the KG represented through i. By abstracting M_{g} and defining query q and i as before, the systems and methods described herein may be configured to allow connections from the graph-aware transformer to be influenced by the task.

To combine the previous initial encoding, which captures relations between the different tokens and the recently introduce graph-aware encoding, the systems and methods described herein may be configured to add the two representation through element-wise addition to generate the output into the final encoding layer. The systems and methods described herein may be configured to rate a prediction task using the final encoding of query q and item i, concentrating the representation for q and the representation for i before performing an inner product to produce a final rating, represented as a score of 1-5 (e.g., or any other suitable score or range of scores).

The systems and methods described herein may be configured to pass the representation through a fully connected linear layer as the encoder hidden state and decode the representation into its respective output tokens. The systems and methods described herein may be configured to perform decoding in an auto-regressive manner, as in adjacent natural language generation tasks, which take an encoder-decoder approach. The decoder may include a left-to-right decoder (e.g., or any other suitable decoder), with a causal attention mask which masks tokens to the right of the current output time-step.

Each explanation and/or justification in the dataset may depend from a respective item. Thus, to avoid data leaking into the train/development/test set, the systems and methods described herein may be configured to divide the train/development/test by item (e.g., all items in the test set are unseen during training). The train set may be seen as older items in the catalogue that have a history of purchase. As illustrated in FIG. 3B, during training, the systems and methods described herein may be configured to provide the ground truth item explanations to perform teacher forcing on the model, where the ground truth is given as subsequent input instead of the generated output of previous tokens.

In the training phase, the input may include: past query-item associations (e.g., user-item matrix, purchase history); item descriptions; item knowledge graph; any other suitable input; any suitable combination thereof. The output may include: the explanation; a rating prediction score; any other suitable output; any suitable combination thereof. Explanations E may be extracted from item descriptions D: E⊆D. The systems and methods described herein may be configured to provide at least two outputs: a rating prediction score r\hat{ }_{u,i}; and natural language explanation E, which justifies the rating by verbalizing the KG corresponding to the item. The systems and methods described herein may be configured to perform multi-task learning to learn both tasks and define regularization weights λ, to weight the two tasks. Taking Lᵣ and Lₑ to represent the recommendation and explanation cost functions, respectively, the multi-task cost L then becomes:

$$L = {λ}_{r} {L}_{r} + {λ}_{e} {L}_{e} , \qquad ( 3 )$$

where λᵣ and λₑ denote the respective rating prediction and explanation regularization weights. The systems and methods described herein may be configured to detail a cost function Lᵣ, the ratings predictions loss, by utilizing Mean Square Error (MSE) as the cost function:

$${ℒ}_{r} = \frac{1}{( U , I )} {\sum }_{( u , i ) ∈ ( U , I )} ( {r}_{u , i} - {\tilde{r}}_{u , i} ) , \qquad ( 4 )$$

where (U,I) denotes the total set of query-item pairs and r_{u,i} denotes the true prediction score. The systems and methods described herein may be configured to incorporate negative log-likelihood (NLL) as the cost function of the explanation Lₑ. Thus, Lₑ is defined as:

$${ℒ}_{e} = \frac{1}{\vert ( U , I ) \vert} {\sum }_{( u , i ) ∈ ( U , I )} \frac{1}{\vert {E}_{u , i} \vert} {{\sum }_{i = 1}}^{\vert {E}_{u , i} \vert} - log {p}_{t}^{{e}_{i}} \qquad ( 5 )$$

During inference, as illustrated in FIG. 3C, no item explanation is given, and the model is expected to produce an explanation. Thus, tokens generated at previous time steps serve as input to generate tokens in future time steps. For example, token t₁ would serve as input to the decoder component to generate t₂, . . . , and tₙ to generate tₙ₊₁. Because the explanations are based on item descriptions, the systems and methods described herein may be configured to operate on a new set of items, which have not yet been consumed by the model. The systems and methods described herein may be configured to use two settings of input based on whether an item is new or not new. In the setting where there are new items, the input of consists of: query (not present in the past query-item associations); new item descriptions; and/or new item knowledge graphs.

Additionally, or, alternatively, the systems and methods described herein may be configured to, if there is no new item, use an input that consists of: query (in the past query-item associations); and/or item knowledge graphs. For any input, the systems and methods described herein may be configured to output: the explanation; and the rating prediction score.

In some embodiments, unseen queries q can also be introduced (e.g. new users or new requirement documents). In the case of new users, q can be represented via a profile or attributes, as a set of features or KG (e.g., similar to that of the item). In the case of new requirement documents, q can be represented via natural language sentences or keywords/features extracted from the natural language sentences. The keywords, viewed as constraints, may be constructed into a KG for q.

In some embodiments, the systems and methods described herein may be configured to combine a knowledge graph-based rating recommendation algorithm with a recommendation explanation generation algorithm, which provides a justification to the recommendation. The systems and methods described herein may be configured to be grounded on knowledge graph facts and able to produce a natural language explanation for a target item. The systems and methods described herein may be configured to receive as input features of an item, which are structured via a knowledge graph. The systems and methods described herein may be configured to generate natural language explanations, which focus on item features rather than user reviews. The systems and methods described herein may be configured to leverages pre-defined structured data for a target item, and translate the structured data into sentences.

The systems and methods described herein may be configured to provide a data-driven explanation generation output that is scalable to new items which have may not have a purchase history. The systems and methods described herein may be configured to use structured features of an item. The systems and methods described herein may be configured to generate recommendation explanations by employing message passing networks on the knowledge graph input.

In some embodiments, the systems and methods described herein may be configured to provide a recommendation and a natural language explanation of the recommendation. The systems and methods described herein may be configured to receive query data. The query data may include purchase history data. The purchase history data may include a string representation of previously purchased items associated with at least one of the user and at least one other user. The query data may include customer requirement data. The customer requirement data may be represented via a tokenization of extracted keywords associated with the query.

The systems and methods described herein may be configured to receive item data. The systems and methods described herein may be configured to initialize the query data as at least one natural language query token. The systems and methods described herein may be configured to initialize the item data as at least one natural language item token.

The systems and methods described herein may be configured to generate a knowledge graph for the item based on the at least one natural language item token. The knowledge graph for the item may include denotation tokens. The denotation tokens may include at least a head token. The head token may include a topic of the knowledge graph for the item. The knowledge graph for the item may include a star-shaped knowledge graph. A center node of the knowledge graph for the item may include an item entity associated with the item.

The systems and methods described herein may be configured to flatten the knowledge graph for the item to generate a knowledge graph string. The systems and methods described herein may be configured to map at least one token associated with the knowledge graph string and the at least one natural language query token to an embedding vector using a matrix of parameters. The parameters include randomly initialized parameters or any other suitable parameters.

The systems and methods described herein may be configured to provide, to a machine learning model, the embedding vector. The systems and methods described herein may be configured to receives, from the machine learning model, a recommendation and a natural language explanation of the recommendation. The systems and methods described herein may be configured to provide, to a user at a display, the recommendation and the natural language explanation of the recommendation.

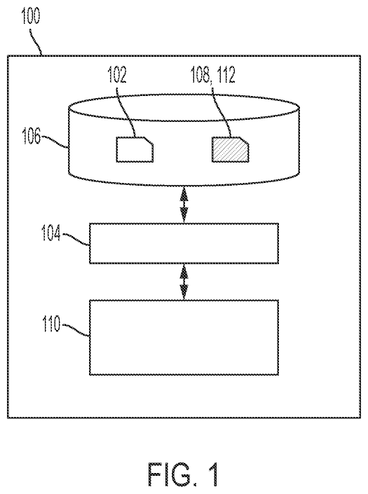

FIG. 1 shows a system 100 for training a neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104.

In some embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers.

The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network.

The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In some embodiments, the data representation 112 may be stored separately from the data representation 108 defining the ‘untrained’ neural network. In some embodiments, the output interface may be separate from the data storage interface 104, but may in general be of a type as described above for the data storage interface 104.

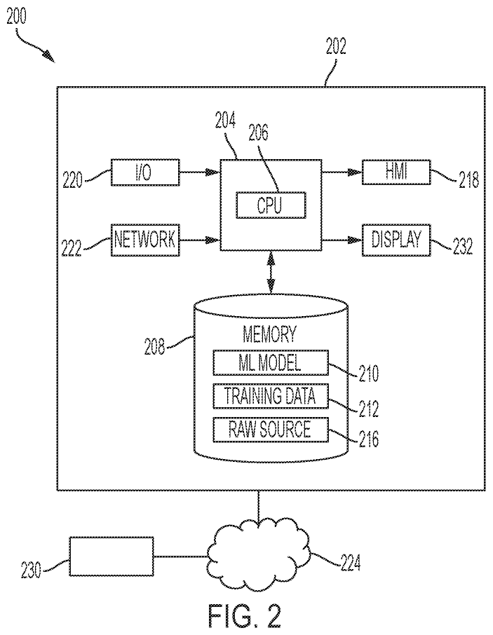

FIG. 2 generally illustrates a data annotation/augmentation system 200 configured to provide embodied sound event predictions. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction stet such as one of the x86, ARM, Power, or MIPS instruction set families.

During operation, the CPU 206 may execute stored program instructions that are retrieved from the memory unit 208. The stored program instructions may include software that controls operation of the CPU 206 to perform the operation described herein. In some embodiments, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 (e.g., represented in FIG. 2 as the ML Model 210) or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning model 210 (e.g., which may be referred to as the machine-learning algorithm 210) that is configured to analyze the raw source dataset 216. The raw source dataset 216 may include raw or unprocessed sensor data that may be representative of an input dataset for a machine-learning system. The raw source dataset 216 may include video, video segments, audio, audio segments, images, text-based information, and raw or partially processed sensor data (e.g., radar map of objects). In some embodiments, the machine-learning model 210 may be a neural network algorithm that is designed to perform a predetermined function. For example, the neural network algorithm may be configured in automotive applications to identify pedestrians in video images.

The computer system 200 may store a training dataset 212 for the machine-learning model 210. The training dataset 212 may represent a set of previously constructed data for training the machine-learning model 210. The training dataset 212 may be used by the machine-learning model 210 to learn weighting factors associated with a neural network algorithm. The training dataset 212 may include a set of source data that has corresponding outcomes or results that the machine-learning model 210 tries to duplicate via the learning process. In this example, the training dataset 212 may include audio data, environmental data, dialog data, other suitable data, and/or the like.

The machine-learning model 210 may be operated in a learning mode using the training dataset 212 as input. The machine-learning model 210 may be executed over a number of iterations using the data from the training dataset 212. With each iteration, the machine-learning model 210 may update internal weighting factors based on the achieved results. For example, the machine-learning model 210 can compare output results (e.g., annotations) with those included in the training dataset 212. Since the training dataset 212 includes the expected results, the machine-learning model 210 can determine when performance is acceptable. After the machine-learning model 210 achieves a predetermined performance level (e.g., 100% agreement with the outcomes associated with the training dataset 212), the machine-learning model 210 may be executed using data that is not in the training dataset 212. The trained machine-learning model 210 may be applied to new datasets to identify sound events in audio data put to the machine-learning model 210.

The machine-learning model 210 may be configured to identify a particular feature in the raw source data 216. The raw source data 216 may include a plurality of instances or input dataset for which various predictions are desired. The machine-learning model 210 may be programmed to process the raw source data 216 to identify the presence of the particular features. The machine-learning model 210 may be configured to predict, using the raw source data 216, sound events in various audio data. The raw source data 216 may be derived from a variety of sources. For example, the raw source data 216 may be actual input data collected by a machine-learning system. The raw source data 216 may be machine generated for testing the system.

In the example, the machine-learning model 210 may process raw source data 216 and output a prediction. The machine-learning model 210 may generate a confidence level (e.g., a certainty value) or factor for each output generated. For example, a confidence value that exceeds a predetermined high-confidence threshold may indicate that the machine-learning model 210 is confident that the prediction. A confidence value that is less than a low-confidence threshold may indicate that the machine-learning model 210 has some uncertainty that the prediction is accurate.

In some embodiments, the system 200 may, using a machine-learning model, such as the machine-learning model 210, receive input dialog captured by an input mechanism (e.g., such as a microphone, keyboard, and/or any other suitable input mechanism). The input dialog may include a text string corresponding to a query.

The system 200, using the machine-learning model 210, may extract, using at least one functional map, at least one keyword from the text string. The at least one functional map may correspond to a neural functional approximator and/or may correlate one or more maps associated with one or more image inputs with corresponding region and object labels. The system 200, using the machine-learning model 210, may generate at least one action prediction based on an input state representation and the at least one keyword. The at least one action prediction may include an action to navigate at least a portion of the environment associated with the machine-learning model 210 and/or other suitable action. The system 200 may predict any suitable number of actions for traversing the environment.

The system 200 may receive, via an image capturing device, one or more images associated with the environment. The system 200, using the machine-learning model 210, may provide a prediction, using the one or more images, identifying one or more objects in the one or more images. Additionally, or alternatively, the system 200 may receive various audio data. The system 200, using the machine learning model 210, may provide a prediction, using the various audio data, identifying target sound event of the various audio data. The system 200 may provide, at an output mechanism (e.g., such as the display 232, HMI 218, I/o 220, or any other suitable mechanism), the prediction.

The system 200 may store, in an associated memory, such as the memory 208 or other suitable memory, the text string, the at least one sub-goal, any other suitable date or information, or a combination thereof. The system 200 my receive feedback in response to providing the prediction. For example, a user of the system 200 may provide verbal, textual or other suitable feedback (e.g., as an input) based on the perspective of the user that the prediction is accurate or correct. The system 200 may subsequently train the machine-learning model 210 based on the feedback (e.g., in order to improve future predations).

In some embodiments, the system 200 may be configured to provide a recommendation and a natural language explanation of the recommendation. The system 200 may receive query data. The system 200 may receive item data. The system 200 may initialize the query data as at least one natural language query token. The system 200 may initialize the item data as at least one natural language item token.

The system 200 may generate a knowledge graph for the item based on the at least one natural language item token. The system 200 may flatten the knowledge graph for the item to generate a knowledge graph string. The system 200 may map at least one token associated with the knowledge graph string and the at least one natural language query token to an embedding vector using a matrix of parameters. The parameters include randomly initialized parameters or any other suitable parameters.

The system 200 may provide, to the machine learning model 210, the embedding vector. The system 200 may receives, from the machine learning model 210, a recommendation and a natural language explanation of the recommendation. The system 200 may provide, to a user at the display 232 or other suitable display, the recommendation and the natural language explanation of the recommendation.

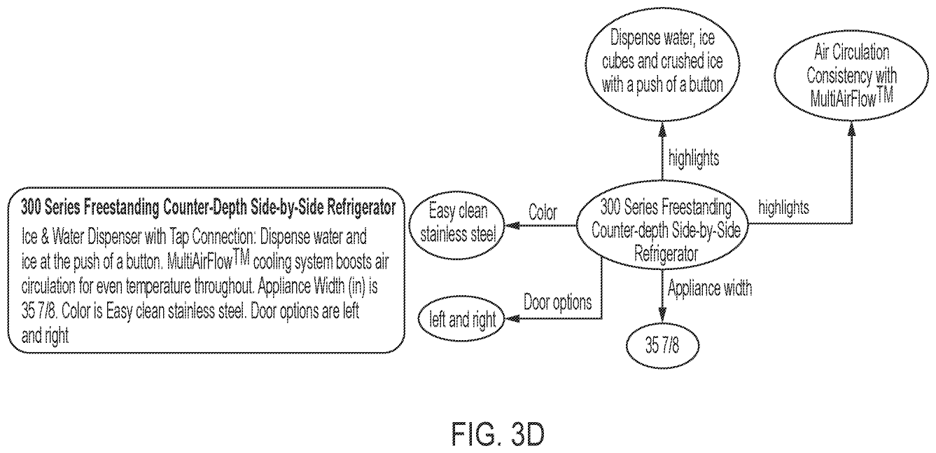

It should be understood that the systems and methods described herein may be configured to perform any suitable function, such as those described herein with respect to FIGS. 5-11.

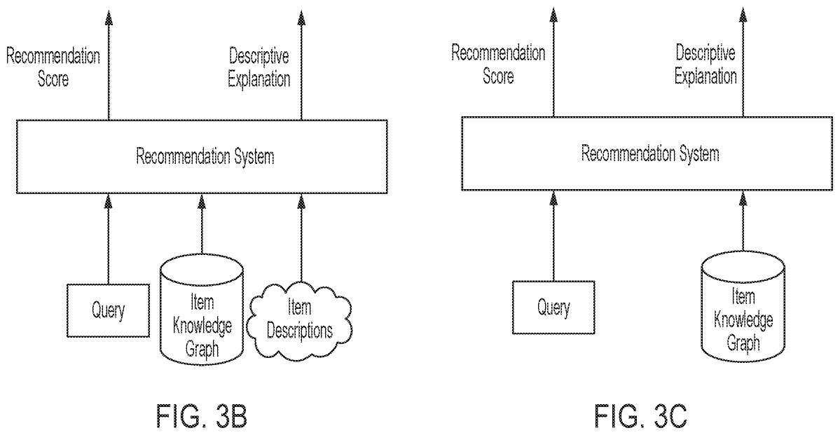

FIG. 4 is a flow diagram generally illustrating a recommendation and explanation generation method 400 according to the principles of the present disclosure. It should be understood that any of the systems described herein, including, but not limited to, the system 200, may be configured to perform the methods described herein. At 402, the method 400 receives query data.

At 404, the method 400 receives item data.

At 406, the method 400 initializes the query data as at least one natural language query token.

At 408, the method 400 initializes the item data as at least one natural language item token.

At 410, the method 400 generates a knowledge graph for the item based on the at least one natural language item token.

At 412, the method 400 flattens the knowledge graph for the item to generate a knowledge graph string.

At 414, the method 400 maps at least one token associated with the knowledge graph string and the at least one natural language query token to an embedding vector using a matrix of parameters.

At 416, the method 400 provides, to a machine learning model, the embedding vector.

At 418, the method 400 receives, from the machine learning model, a recommendation and a natural language explanation of the recommendation.

At 420, the method 400 provides, to a user at a display, the recommendation and the natural language explanation of the recommendation.

FIG. 5 depicts a schematic diagram of an interaction between computer-controlled machine 500 and control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic and motion sensors. In some embodiments, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes classifier 514. Classifier 514 may be configured to classify input signals x into one or more labels using a machine-learning (ML) algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In some embodiments, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In some embodiments, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., ML algorithms) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more ML algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the ML algorithms and/or methodologies as disclosed herein. Non-volatile storage 516 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

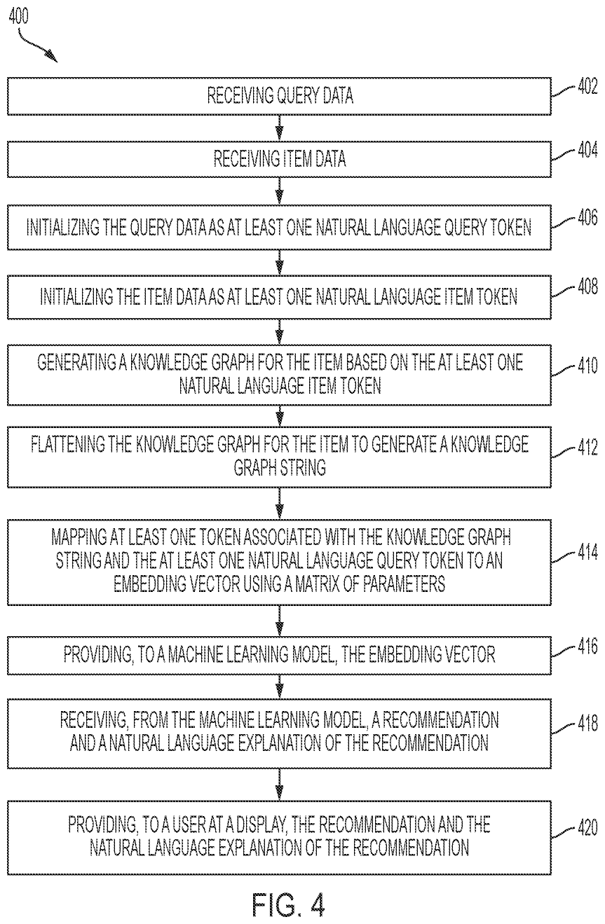

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects.

In some embodiments, the vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In some embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In some embodiments, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

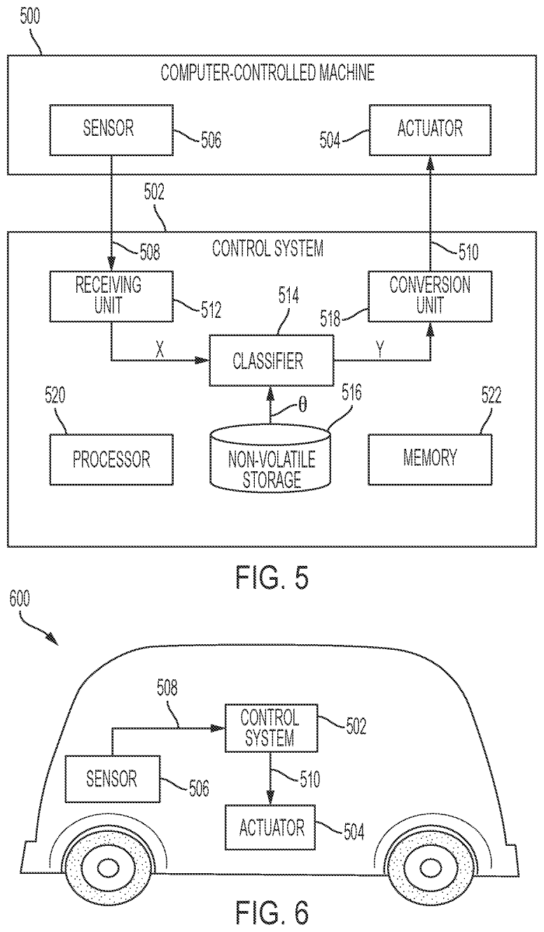

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 706 of system 700 (e.g., manufacturing machine) depending on the determined state of manufactured product 704.

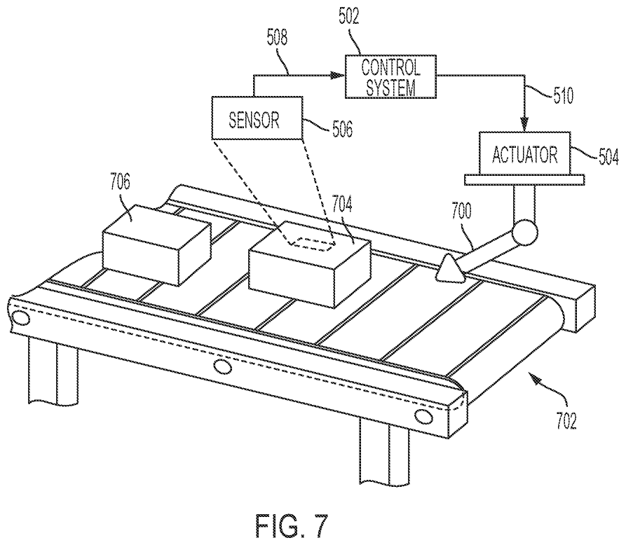

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

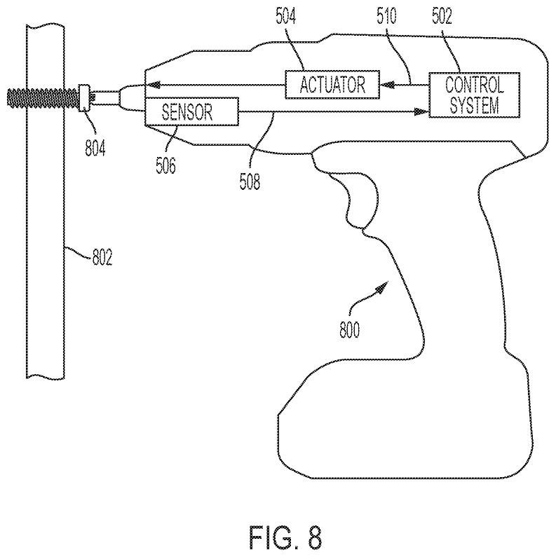

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

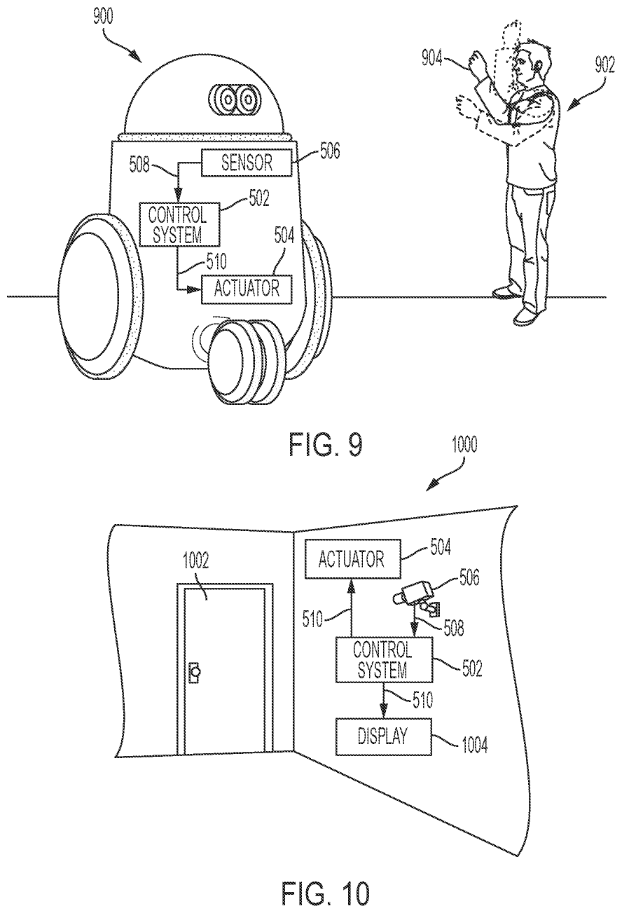

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In some embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

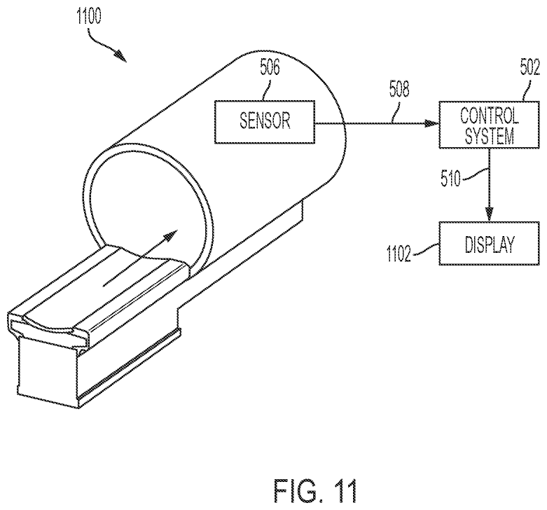

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region.

In some embodiments, a method for providing a recommendation and a natural language explanation of the recommendation includes receiving query data, receiving item data, initializing the query data as at least one natural language query token, and initializing the item data as at least one natural language item token. The method also includes generating a knowledge graph for the item based on the at least one natural language item token, flattening the knowledge graph for the item to generate a knowledge graph string, mapping at least one token associated with the knowledge graph string and the at least one natural language query token to an embedding vector using a matrix of parameters, and providing, to a machine learning model, the embedding vector. The method also includes receiving, from the machine learning model, a recommendation and a natural language explanation of the recommendation, and providing, to a user at a display, the recommendation and the natural language explanation of the recommendation.

In some embodiments, the query data includes purchase history data. In some embodiments, the purchase history data includes a string representation of previously purchased items associated with at least one of the user and at least one other user. In some embodiments, the query data includes customer requirement data. In some embodiments, the customer requirement data is represented via a tokenization of extracted keywords associated with the query. In some embodiments, the knowledge graph for the item includes denotation tokens. In some embodiments, the denotation tokens include at least a head token. In some embodiments, the head token includes a topic of the knowledge graph for the item. In some embodiments, the knowledge graph for the item includes a star-shaped knowledge graph. In some embodiments, a center node of the knowledge graph for the item includes an item entity associated with the item. In some embodiments, the parameters include randomly initialized parameters.

In some embodiments, a system for providing a recommendation and a natural language explanation of the recommendation includes a processor, and a memory. The memory includes instructions that, when execute by the processor, cause the processor to: receive query data; receive item data; initialize the query data as at least one natural language query token; initialize the item data as at least one natural language item token; generate a knowledge graph for the item based on the at least one natural language item token; flatten the knowledge graph for the item to generate a knowledge graph string; map at least one token associated with the knowledge graph string and the at least one natural language query token to an embedding vector using a matrix of parameters; provide, to a machine learning model, the embedding vector; receive, from the machine learning model, a recommendation and a natural language explanation of the recommendation; and provide, to a user at a display, the recommendation and the natural language explanation of the recommendation.

In some embodiments, the query data includes purchase history data. In some embodiments, the purchase history data includes a string representation of previously purchased items associated with at least one of the user and at least one other user. In some embodiments, the query data includes customer requirement data. In some embodiments, the customer requirement data is represented via a tokenization of extracted keywords associated with the query. In some embodiments, the knowledge graph for the item includes denotation tokens. In some embodiments, the denotation tokens include at least a head token. In some embodiments, the head token includes a topic of the knowledge graph for the item.

In some embodiments, an apparatus for providing a recommendation and a natural language explanation of the recommendation includes a processor, and a memory. The memory includes instructions that, when executed by the processor, cause the processor to: receive query data; receive item data; initialize the query data as at least one natural language query token; initialize the item data as at least one natural language item token; generate a star-shaped knowledge graph for the item based on the at least one natural language item token; flatten the knowledge graph for the item to generate a knowledge graph string; map at least one token associated with the knowledge graph string and the at least one natural language query token to an embedding vector using a matrix of randomly initialized parameters; provide, to a machine learning model, the embedding vector; receive, from the machine learning model, a recommendation and a natural language explanation of the recommendation; and provide, to a user at a display, the recommendation and the natural language explanation of the recommendation.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for providing a recommendation and a natural language explanation of the recommendation, the method comprising:
receiving query data;
receiving item data;
initializing the query data as at least one natural language query token;
initializing the item data as at least one natural language item token;
generating a knowledge graph for the item based on the at least one natural language item token;
flattening the knowledge graph for the item to generate a knowledge graph string;
mapping at least one token associated with the knowledge graph string and the at least one natural language query token to an embedding vector using a matrix of parameters;
providing, to a machine learning model, the embedding vector;
receiving, from the machine learning model, a recommendation and a natural language explanation of the recommendation; and
providing, to a user at a display, the recommendation and the natural language explanation of the recommendation.

2. The method of claim 1, wherein the query data includes purchase history data.

3. The method of claim 2, wherein the purchase history data includes a string representation of previously purchased items associated with at least one of the user and at least one other user.

4. The method of claim 1, wherein the query data includes customer requirement data.

5. The method of claim 4, wherein the customer requirement data is represented via a tokenization of extracted keywords associated with the query.

6. The method of claim 1, wherein the knowledge graph for the item includes denotation tokens.

7. The method of claim 6, wherein the denotation tokens include at least a head token.

8. The method of claim 7, wherein the head token includes a topic of the knowledge graph for the item.

9. The method of claim 1, wherein the knowledge graph for the item includes a star-shaped knowledge graph.

10. The method of claim 9, wherein a center node of the knowledge graph for the item includes an item entity associated with the item.

11. The method of claim 1, wherein the parameters include randomly initialized parameters.

12. A system for providing a recommendation and a natural language explanation of the recommendation, the system comprising:
a processor; and
a memory including instructions that, when execute by the processor, cause the processor to:
receive query data;
receive item data;
initialize the query data as at least one natural language query token;
initialize the item data as at least one natural language item token;
generate a knowledge graph for the item based on the at least one natural language item token;
flatten the knowledge graph for the item to generate a knowledge graph string;
map at least one token associated with the knowledge graph string and the at least one natural language query token to an embedding vector using a matrix of parameters;
provide, to a machine learning model, the embedding vector;
receive, from the machine learning model, a recommendation and a natural language explanation of the recommendation; and
provide, to a user at a display, the recommendation and the natural language explanation of the recommendation.

13. The system of claim 12, wherein the query data includes purchase history data.

14. The system of claim 13, wherein the purchase history data includes a string representation of previously purchased items associated with at least one of the user and at least one other user.

15. The system of claim 12, wherein the query data includes customer requirement data.

16. The system of claim 15, wherein the customer requirement data is represented via a tokenization of extracted keywords associated with the query.

17. The system of claim 12, wherein the knowledge graph for the item includes denotation tokens.

18. The system of claim 17, wherein the denotation tokens include at least a head token.

19. The system of claim 18, wherein the head token includes a topic of the knowledge graph for the item.

20. An apparatus for providing a recommendation and a natural language explanation of the recommendation, the apparatus comprising:
a processor; and
a memory including instructions that, when executed by the processor, cause the processor to:
receive query data;
receive item data;
initialize the query data as at least one natural language query token;
initialize the item data as at least one natural language item token;
generate a star-shaped knowledge graph for the item based on the at least one natural language item token;
flatten the knowledge graph for the item to generate a knowledge graph string;
map at least one token associated with the knowledge graph string and the at least one natural language query token to an embedding vector using a matrix of randomly initialized parameters;
provide, to a machine learning model, the embedding vector;
receive, from the machine learning model, a recommendation and a natural language explanation of the recommendation; and
provide, to a user at a display, the recommendation and the natural language explanation of the recommendation.
